(19) United States
(12) Patent Application Publication
(10) Pub. No.: US 2013/0146016 A1
(43) Pub. Date: Jun. 13, 2013

(54) CYLINDER HEAD FOR VEHICLE

(71) Applicant: Hyundai Motor Company, Seoul (KR)

(72) Inventor: Bongseong Kang, Hwaseong-si (KR)

(73) Assignee: Hyundai Motor Company, Seoul (KR)

(21) Appl. No.: 13/707,187

(22) Filed: Dec. 6, 2012

(30) Foreign Application Priority Data
Dec. 9, 2011 (KR) 10-2011-0132258
Oct. 17, 2012 (KR) 10-2012-0115636

(51) Int. Cl. F02F 1/24

(52) U.S. Cl. CPC F02F 1/242
USPC 123/193.5

(57) ABSTRACT

A cylinder head for a vehicle has combustion chambers, each of which includes one exhaust opening and two intake openings, wherein each of the combustion chambers includes an intake port formed with one side thereof branched so as to be connected to the two intake openings, and a spark plug for igniting an air-fuel mixture within a corresponding combustion chamber, wherein an exhaust port may be connected to the exhaust opening of the respective combustion chambers, and wherein the exhaust port has one side thereof branched that may be connected to the exhaust opening of the respective combustion chambers and the other side thereof may be integrally formed in an integrated shape.

### CROSS-REFERENCE TO RELATED APPLICATION

The present application claims priority to Korean Patent Application No. 10-2011-0132258 and 10-2012-0115636 filed on Dec. 9, 2011 and Oct. 17, 2012, the entire contents of which is incorporated herein for all purposes by this reference.

### BACKGROUND OF THE INVENTION

1. Field of the Invention

The present invention relates to a cylinder head for a vehicle, and more particularly, to a cylinder head for a vehicle having a two-cylinder engine.

2. Description of Related Art

In general, a cylinder head, being the head portion of an engine, is installed on the upper surface of a cylinder. Further, the cylinder head is formed to maintain air-tightness and water-tightness so as to achieve thermal energy. In addition, a combustion chamber is formed within the cylinder head, and a spark plug, an intake valve, and an exhaust valve are installed in the combustion chamber.

The combustion chamber is a space formed by the cylinder, a piston, and the cylinder head, Further, an exhaust port and an intake port are formed in the cylinder head and are connected to the combustion chamber. The intake valve and the exhaust valve selectively open and close the exhaust port and the intake port.

The exhaust port is connected to an exhaust manifold. The exhaust port also relays exhaust gas exhausted from the combustion chamber of the cylinder to the exhaust manifold. Further, the exhaust manifold relays the exhaust gas to an exhaust pipe.

A plurality of combustion chambers is formed in a cylinder head. In addition, in order to form a connecting portion capable of connecting all the exhaust ports of the respective combustion chambers, the weight of the exhaust manifold may be increased. In a case in which the weight of the exhaust manifold is reduced according to a shape of the exhaust port is simplified, interference between the exhaust port and the spark plug may be generated or ignition efficiency of the spark plug may be deteriorated.

In detail, in order to prevent interference with the exhaust port connected to the combustion chamber, the spark plug may not be oriented toward the center of the combustion chamber. Therefore, the ignition efficiency of the spark plug may be deteriorated. in addition, when the spark plug is installed oriented toward the center of the combustion chamber, interference with the exhaust port may occur.

Therefore, a cylinder head that the weight of the exhaust manifold is reduced according to a shape of the exhaust port is simplified, and also interference between the exhaust port and the spark plug are prevented so as to improve the ignition efficiency of the spark plug is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a cylinder head for a vehicle in which a spark plug may be oriented toward the center of a combustion chamber without interfering with an exhaust port.

The present invention has also been made in an effort to provide a cylinder head for a vehicle that may reduce the weight of an exhaust manifold.

In an aspect of the present invention, a cylinder head for a vehicle may have combustion chambers, each of which may include one exhaust opening and two intake openings, wherein each of the combustion chambers may include an intake port formed with one side thereof branched so as to be connected to the two intake openings, and a spark plug for igniting an air-fuel mixture within a corresponding combustion chamber, wherein an exhaust port is connected to the exhaust opening of the respective combustion chambers, and wherein the exhaust port may have one side thereof branched that is connected to the exhaust opening of the respective combustion chambers and the other side thereof is integrally formed in an integrated shape.

The exhaust opening of the respective combustion chambers is formed in a portion at which the respective combustion chambers are adjacent to each other, wherein the spark plug of the respective combustion chambers is disposed to an outside relative to the exhaust port of the respective combustion chambers.

The spark plug of the respective combustion chambers is adapted to slant at a set angle from a base line perpendicular to a center line connecting centers of the combustion chambers, to an outside so as to dispose toward the centers of the combustion chambers.

The set angle is an acute angle.

A water jacket is disposed at a space between the spark plug of the respective combustion chambers and the exhaust port.

A water jacket is disposed between the combustion chambers.

One of the combustion chambers and the other of the combustion chambers are symmetrically formed.

An exhaust port connected to one of the combustion chambers, a spark plug of one of the combustion chambers, and an intake port of one of the combustion chambers is disposed symmetrically with an exhaust port connected to the other of the combustion chambers, a spark plug of the other of the combustion chambers, and an intake port of the other of the combustion chambers.

The spark plug of the respective combustion chambers is adapted to slant at a slant angle from a vertical line aligned vertically upwards from a center line passing respective centers of the combustion chambers so as to dispose toward the centers of the combustion chambers respectively.

The slant angle is an acute angle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configurative diagram of a cylinder head for a vehicle according to an exemplary embodiment of the present invention.

FIG. 2 is a cross-sectional view illustrating a spark plug mounted combustion chamber according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

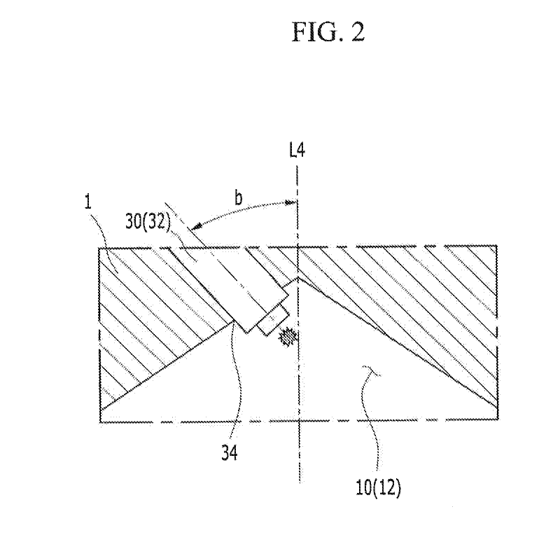

FIG. 1 is a configurative diagram of a cylinder head for a vehicle according to an exemplary embodiment of the present invention.

Meanwhile, FIG. 1 illustrates a core that is used to manufacture a cylinder head, The core is a mold having a shape of a hollow portion that is the empty space in the cylinder head 1, and the core is well known to a person skilled in the art, and thus detailed descriptions will be omitted. In this specification, the constituent elements of the cylinder head 1 and the portions of the core corresponding to the elements will be described without distinction of the names.

As shown in FIG. 1, a cylinder head 1 includes a first combustion chamber 10, a second combustion chamber 12, an exhaust port 20, an exhaust valve hole 22, a first spark plug 30, a second spark plug 32, an intake port 40, a first intake port 42, a second intake port 44, and an intake valve hole 46.

FIG. 1 shows the cylinder head 1 provided in a two-cylinder engine. Therefore, two combustion chambers 10 and 12 are formed in the cylinder head 1.

The first combustion chamber 10 is one combustion chamber of the two combustion chambers. Further, the second combustion chamber 12 is the other combustion chamber of the two combustion chambers.

The exhaust port 20 is connected to the first and second combustion chamber 10 and 12 through exhaust openings 24 of the first and second combustion chambers 10 and 12. Further, one side of the exhaust port 20 is combined as one. In addition, the other side of the exhaust port 20 is branched in two and is connected to the first and second combustion chambers 10 and 12, respectively, That is, the exhaust port 20 connected to the first combustion chamber 10 and the exhaust port 20 connected to the second combustion chamber 12 are integrally formed. Meanwhile, one side of the exhaust port 20 may be connected to an exhaust manifold.

The exhaust valve hole 22 is a hole formed in the cylinder head 1 so that an exhaust valve may be inserted therein, Further, the exhaust valve hole 22 is communicated with the exhaust port 20 so that the exhaust valve may open and close an exhaust opening 24 formed in the combustion chamber. In addition, the first and second combustion chambers 10 and 12 respectively include one exhaust opening 24 and one exhaust valve.

The first spark plug 30 is provided to ignite an air-fuel mixture in the first combustion chamber 10. Further, the second spark plug 32 is provided to ignite an air-fuel mixture in the second combustion chamber 12.

The exhaust port 20 is formed in a portion at which the first combustion chamber 10 and the second combustion chamber 12 are adjacent to one another, and the first spark plug 30 and the second spark plug 32 may be provided to the outside relative to the exhaust port 20, from the portion at which the first combustion chamber 10 and the second combustion chamber 12 are adjacent to one another. Accordingly, it is easy to prevent interference between the exhaust port 20 and the first and second spark plugs 30 and 32, and also dispose the first and second spark plugs 30 and 32 oriented toward the centers C1 and C2 of the combustion chambers 10 and 12. Further, the first and second spark plugs 30 and 32 have a set angle (a) in order to be oriented toward the centers C1 and C2 of the combustion chambers 10 and 12.

The disposition of first and second spark plugs 30 and 32 having the set angle (a) will hereinafter be described in detail.

In FIG. 1, a base line L2 passing the center C1 of the first combustion chamber 10 and a base line L3 passing the center C2 of the second combustion chamber 20 that are perpendicular to a center line L1 passing the centers C1 and C2 of the two combustion chamber 10 and 12 arranged in parallel with each other are illustrated, In addition, the first and second spark plug 30 is disposed to incline toward outside at the set angle (a) from the base line L2. That is, the set angle (a) is included angle between length direction of the first spark plug 30 and the base line L2.

In an exemplary embodiment of the present invention, the set a ay be an acute angle.

Therefore, the first spark plug 30 may be oriented toward the center C1 of the first combustion chamber 10 without interfering with the exhaust port 20. Meanwhile, repetitive descriptions of the second spark plug 32 that disposed to incline toward outside in the opposite direction with the first spark plug 30 and oriented toward the center C2 of the second combustion chamber 12 according to the above-mentioned method will not be provided.

The water jacket 50 is formed so as to cool constituent elements in the cylinder head 1. The manufacturing method and function of the water jacket 50 that formed for circulating coolant into the cylinder head 1 are well-known to a person of ordinary skill in the art, so a detailed description thereof will be omitted.

In FIG. 1 shows the water jacket 50 disposed between the first combustion chamber 10 and the second combustion chamber 12 and between the first and second spark plugs 30 and 32 and the exhaust port 20. Herein, a space for disposing the water jacket 50 may be provided between the first and second spark plugs 30 and 32 and the exhaust port 20 according to the first and second spark plugs 30 and 32 are disposed to incline toward outside.

The intake port 40 includes a first intake port 42 and a second intake port 44.

The first intake port 42 is formed connected to the first combustion chamber 10. Further, one side of the first intake port 42 connected to the first combustion chamber 10 may be formed branched in two, That is, the first intake port 42 is connected to two intake openings 48 formed in the first combustion chamber 10.

The second intake port 44 is formed connected to the second combustion chamber 12. Further, one side of the second intake port 44 connected to the second combustion chamber 12 may be formed branched in two. That is, the second intake port 44 is connected to two intake openings 48 formed in the second combustion chamber 12.

The intake valve hole 46 is a hole formed in the cylinder head 1 for an intake valve to be inserted therein. Further, the intake valve hole 46 is formed to communicated with the intake port 40 so that the exhaust valve may open and close the intake opening 48 formed in the combustion chamber.

The first combustion chamber 10 and the second combustion chamber 12 may be symmetrically formed. Specifically, the exhaust port 20 connected to the first combustion chamber 10, the first spark plug 30, and the first intake port 42 may be disposed symmetrically with the exhaust port 20 connected to the second combustion chamber 12, the second spark plug 32 and the second intake port 44.

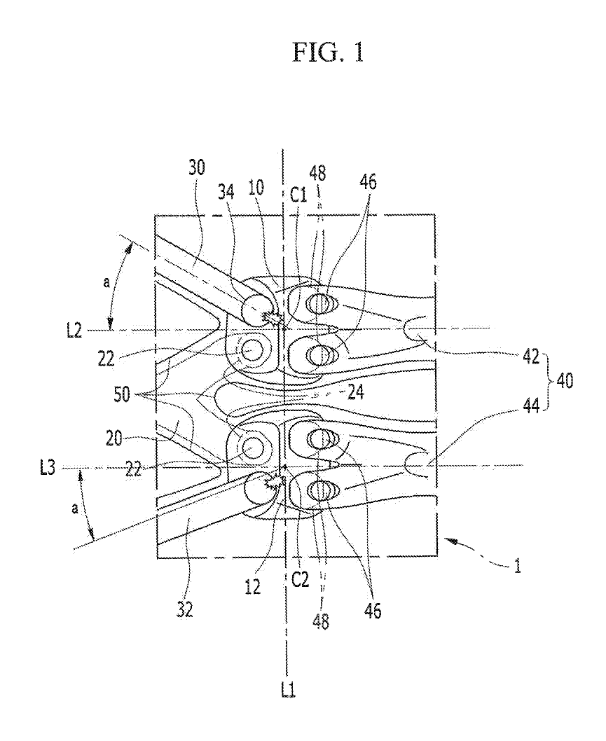

FIG. 2 is a cross-sectional view illustrating a spark plug mounted combustion chamber according to an exemplary embodiment of the present invention.

As shown in FIG. 2, the spark plugs 30 and 32 are mounted to slant at a slant angle (b) from a vertical line L4 respectively passing centers C1 and C2 of the combustion chambers 10 and 12. That is, the slant angle (b) is included angle between length direction of the spark plugs 30 and 32 and the vertical line L4 aligned vertically upwards from the center line L1 passing respective centers C1 and C2.

In an exemplary embodiment of the present invention, the slant angle may be an acute angle.

Therefore, as shown in FIG. 1, the spark plugs 30 and 32 may be disposed toward the centers C1 and C2 of the combustion chambers 10 and 12 although the spark plugs 30 and 32 are inserted through spark plug insertion holes 34, which are deviated from centers C1 and C2 of the combustion chamber 10 and 12.

As described above, according to an exemplary embodiment of the present invention, one end of the exhaust port 20 connected to the exhaust manifold is combined as one, the weight of the exhaust manifold may be reduced. Further, the spark plugs 30 and 32 may be oriented toward the centers of the combustion chambers 10 and 12, while not interfering with the exhaust port 20. in addition, the water jacket 50 disposed space is provided according to the spark plugs 30 and 32 mounted angle, and the contacting surface between the exhaust port 20 and the water jacket 50 may be increased.

The inner shape of the cylinder head 1 may be made simpler, and productivity may be improved.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain. principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cylinder head for a vehicle having combustion chambers, each of which includes one exhaust opening and two intake openings, wherein each of the combustion chambers comprises:
an intake port formed with one side thereof branched so as to be connected to the two intake openings; and
a spark plug for igniting an air-fuel mixture within a corresponding combustion chamber,
wherein an exhaust port is connected to the exhaust opening of the respective combustion chambers, and
wherein the exhaust port has one side thereof branched that is connected to the exhaust opening of the respective combustion chambers and the other side thereof is integrally formed in an integrated shape.

2. The cylinder head for the vehicle of claim 1,
wherein the exhaust opening of the respective combustion chambers is formed in a portion at which the respective combustion chambers are adjacent to each other, and
wherein the spark plug of the respective combustion chambers is disposed to an outside relative to the exhaust port of the respective combustion chambers.

3. The cylinder head for the vehicle of claim 2, wherein the spark plug of the respective combustion chambers is adapted to slant at a set angle from a base line perpendicular to a center line connecting centers of the combustion chambers, to an outside so as to dispose toward the centers of the combustion chambers.

4. The cylinder head for the vehicle of claim 3, wherein the set angle is an acute angle.

5. The cylinder head for the vehicle of claim 1, wherein a water jacket is disposed at a space between the spark plug of the respective combustion chambers and the exhaust port.

6. The cylinder head for the vehicle of claim 3, wherein a water jacket is disposed between the combustion chambers.

7. The cylinder head for the vehicle of claim 1, wherein one of the combustion chambers and the other of the combustion chambers are symmetrically formed.

8. The cylinder head for the vehicle of claim 1, wherein an exhaust port connected to one of the combustion chambers, a spark plug of one of the combustion chambers, and an intake port of one of the combustion chambers is disposed symmetrically with an exhaust port connected to the other of the combustion chambers, a spark plug of the other of the combustion chambers, and an intake port of the other of the combustion chambers.

9. The cylinder head for the vehicle of claim 1, wherein the spark plug of the respective combustion chambers is adapted to slant at a slant angle from a vertical line aligned vertically upwards from a center line passing respective centers of the combustion chambers so as to dispose toward the centers of the combustion chambers respectively.

10. The cylinder head for the vehicle of claim 9, wherein the slant angle is an acute angle.
